(19) United States
(12) Patent Application Publication
(10) Pub. No.: US 2004/0031573 A1
(43) Pub. Date: Feb. 19, 2004

(54) Window covering

(76) Inventor: Reginald Charles Allsopp, Stockport (GB)

Correspondence Address: Mark J. Burns, Esq., HAUGEN LAW FIRM PLLP, 1130 TCF Tower, 121 South Eight Street, Minneapolis, MN, 55402, US

(21) Appl. No.: 10/447,695

(22) Filed: May 29, 2003

(30) Foreign Application Priority Data
May 30, 2002 (GB) 0212494.9

(51) Int. Cl. E06B 3/32

(52) U.S. Cl. 160/89

(57) ABSTRACT

A fabric for use with louver-type vertical blinds is provided. The fabric comprises a flexible drape-material and a band comprising one part of a ‘hook and loop’ fastening system. The part of the ‘hook and loop’ fastening system attached to the fabric includes integral guide markers in order to simplify the attachment of the fabric to a vertical blind. Also provided is a vertical blind comprising the fabric attached to a plurality of vertical louvers.

The present invention relates to a window covering system. More specifically to the provision of a fabric covering for louver type vertical blinds which, when in place, combines the desirable characteristics of both a vertical blind and a conventional window drape. This accommodates the adjustable light transmission features of a vertical blind whilst retaining the aesthetically pleasing characteristics and privacy of a soft draped window covering.

The term ‘window’ is used herein as a convenient reference with the understanding that the invention may also be used as a covering for doors or other architectural openings.

There are many known forms of covering assemblies for windows, including the use of fabric coverings draped from vertically disposed louvers as disclosed in U.S. Pat. Nos. 3,844,330 and 3,851,699. However, whilst these systems provide means for attaching drapery fabric to a vertical blind they do not incorporate positional guide markers within the fabric construction as described herein. The presence of these markers simplifies the initial assembly of the window covering system and periodic re-assembly to allow for laundry of the fabric.

In accordance with the first aspect of this invention there is provided a fabric for use in a vertical louver blind. An upper portion of the fabric incorporates one part of a ‘hook and loop’ fastening system, for example Velcro (TM). The part of the fastening system that is provided on the fabric is adapted for use with vertical blind systems by the provision of guide markers. The guide markers create fastener ‘units’ and simplify the assembly of a covered blind including the fabric of this type. The guide markers are preferably integral to the part of the fastening system which is provided on the fabric and may be incorporated during the manufacture of this component. Thus the guide markers may be formed as part of the fastening system during its manufacture. The guide markers are preferably formed through the omission of portions of the part of the fastening system provided on the fabric. Thus in preferred embodiments the fabric includes one part of a ‘hook and loop’ fastening system wherein each guide marker comprises a gap in which the ‘hooks’ or ‘loops’ are absent.

Preferably, the gaps are equidistantly spaced and have a constant width, the width being defined as the distance between adjacent portions of the part of the fastening system which includes the ‘hooks’ or ‘loops’.

The fabric may comprise a draping material, which may be pleated or unpleated, to which is secured or fixed one part of a ‘hook and loop’ fastening system comprising alternating regions of either the ‘hooks’ or the ‘loops’ and gaps. Preferably, the regions of either the ‘hooks’ or the ‘loops’ have a first width and the gaps have a second width, wherein the first width is greater than the second width.

The guide markers are preferably gaps formed by the omission of portions of the part of the fastening system provided on the fabric. However, it is not intended that the guide markers be restricted to gaps. Alternatively, the guide markers, which facilitate the correct alignment of the fabric material, may be achieved through the addition of equidistantly spaced, contrastingly colored stripes or other indicia. These may be woven into a fastening material which forms a part of the fastening system, or created at a later stage of fabric construction by, for example, the addition of colored stitching or dye to the part of the fastening system attached to the fabric. Additionally or alternatively, each guide marker may be a rigid insert or tag, or arise through a variation in the thickness of either the drape or part of the fastening system. Further, the guide marker may be formed by breaks in the part of the fastening system provided on the fabric such that each fastening unit comprises an isolated portion of said fastening system.

The fabric is suitable for use in a vertical blind which includes a plurality of vertical vanes or louvers, wherein an upper portion of each louver includes the other part of the ‘hook and loop’ fastening system. Each louver has a pair of opposed major surfaces and in preferred embodiments an upper portion of each major surface includes a region provided with the other part of the ‘hook and loop’ system. In such applications, the regions of ‘hooks’ or ‘loops’ on an upper portion of the fabric are preferably alignable with corresponding regions of the other of the ‘hooks’ or ‘loops’ provided on the louvers. Furthermore, the guide markers may correspond to regions of the louver, which are not provided with the other part of the ‘hook and loop’ fastening system. Thus, the markers are preferably introduced at distance intervals corresponding substantially to the width of the louver in the vertical blind system for which the fabric will act as a covering.

The drape-material will ideally be translucent with aesthetically pleasing draping qualities. It may be a woven or non-woven, for example a knitted or melt-bonded material. However, it is not intended that the drape-material be restricted to translucent textiles. The material used may alternatively be opaque. Additionally or alternatively the fabric may be resistant to fading, heat or light transmission, as appropriate.

According to a second aspect of the present invention there is provided a vertical louver blind comprising a plurality of vertical louvers or vanes and a fabric according to the first aspect of the invention. The fabric includes an upper portion provided with one part of a ‘hook and loop’ fastening system and each louver includes a region of the other part of the ‘hook and loop’ fastening system. Preferably the fastening system will be arranged such that the fabric is releasably secured to the upper portion of some or all of the louvers via the ‘hook and loop’ fastening system. This provides a drape-like window covering through which light may be selectively transmitted according to the rotational position of the fabric-supporting louvers.

The part of the fastening system which is not provided on the fabric is secured to the upper portion of the louvers, for example with an adhesive. Preferably the guide markers indicate to a user assembling the blind how the drape fabric should be attached to the louvers. More preferably the fabric will be attached such that the fastening units provided on the fabric are secured to respective units provided on each major face of the louver, with intermediate portions of fabric which are not secured to the louver adjacent thereto.

The louver will ideally be formed from a plastics material such as polyvinyl chloride (PVC). This may be opaque or translucent and may include an anti-static coating. The louver may alternatively be formed from smooth edged metal, wood or, when appropriate, from a rigid or semi-rigid fabric material.

The lower portion of the fabric cover may be stitched and/or weighted. In addition it may be secured to a lower portion of the louver via a securing means, such as a ‘hook and loop’ fastening system as described above for securing the upper portion of the fabric covering. The portions of the fabric which are located at either side of the lower portion of the louver may be releasably secured to each other, thereby. sandwiching the louver between them, and/or each portion may be releasably secured to the louver itself.

Additionally or alternatively, the lower portion of the fabric covering may be secured using an I-shaped tag and/or a ‘hook and loop’ fastening system.

In such embodiments the fabric will be releasably secured to and/or around a lower portion of the louver by the securing means.

Preferably the securing means will restrict unwanted movement of the fabric which hangs at either side of the louver, thereby stabilising the window covering against circulating air whilst maintaining the drape-like appearance of the system.

In embodiments where a second ‘hook and loop’ fastening system is used to secure the fabric to lower portions of the louvers, the part of the ‘hook and loop’ fastening system attached to the fabric may be attached by stitching or adhesive. In the case of an adhesively attached ‘hook’ or ‘loop’ part, a secondary attachment means, such as an I-shaped tag may be used to prevent unwanted removal of the fastening system part e.g. during the washing of the fabric.

The lower portion of the fabric covering may be secured using a ‘hook and loop’ fastening system wherein discrete portions of the ‘hooks’ or the ‘loops’ are secured to the fabric covering at appropriate distance intervals. Preferably the portions of ‘hooks’ and ‘loops’ are substantially circular regions, one of which is fixed to the fabric covering, e.g. by stitching, or adhesive, and the complementary region of which is secured to the louver, e.g. by adhesive.

In embodiments where the securing means for the lower portions of the fabric is a ‘hook and loop’ fastening system, the portions of the ‘hook and loop’ fastening system are preferably regularly spaced, are of a constant size and are fixed to the fabric covering at a constant distance from the lower edge of the fabric covering.

An embodiment of the invention will now be described in detail, by way of example only, with reference to the accompanying drawings, in which:

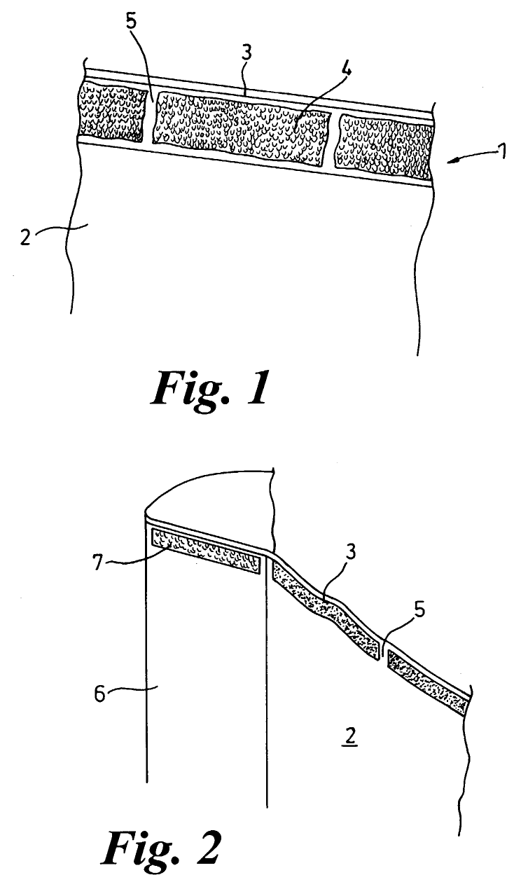

FIG. 1 shows a part of the fastening system provided on the fabric according the first aspect of the invention;

FIG. 2 is a perspective view showing more detail of the ‘hook and loop’ fastening assembly as shown in FIG. 1;

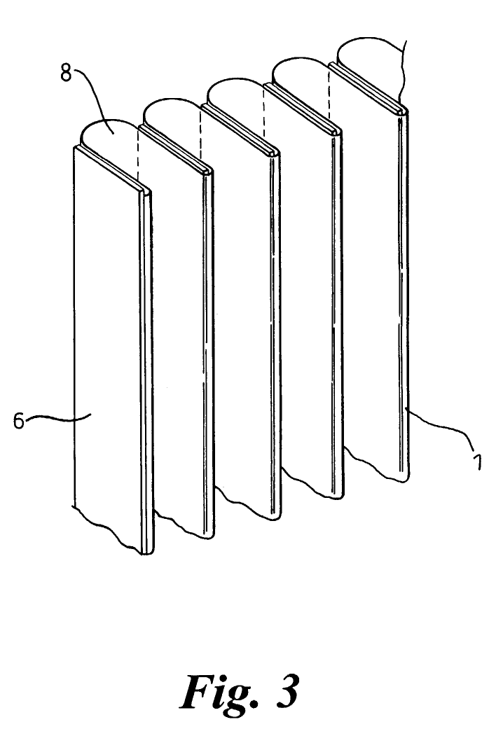

FIG. 3 shows a vertical louver blind according to the second aspect of the invention with the head rail deleted for clarity;

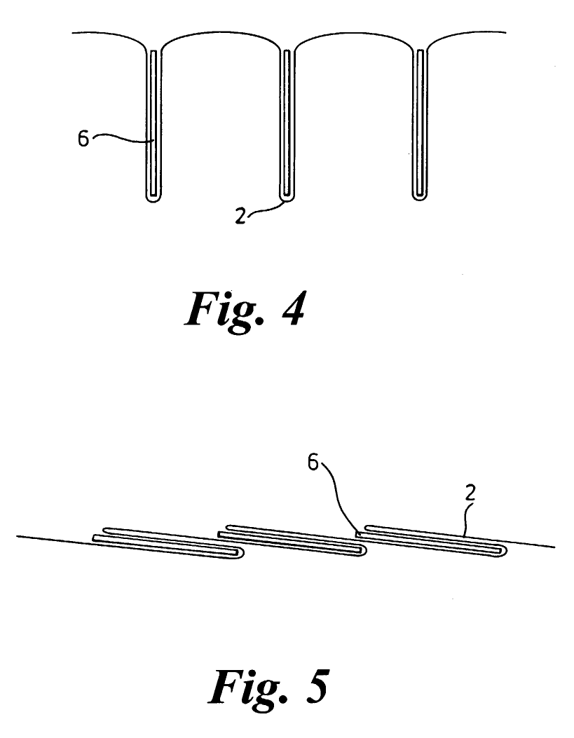

FIG. 4 is a plan view of assembly shown in FIG. 3, with the louvers in an open configuration;

FIG. 5 is a plan view similar to that of FIG. 4, but with the louvers in a closed configuration;

For the avoidance of doubt it should be noted that in this specification reference to ‘up’, ‘down’, ‘upper’, ‘lower’, ‘vertical’, ‘horizontal’, ‘front’, ‘back’ and related terms refers to the orientation that the components of the blind adopt when installed for normal use, as they are shown in the figures.

FIG. 1 shows a portion of a fabric, 1 according to of the first aspect of the present invention. The fabric 1 comprises a translucent flexible drape-material 2 with a band of an ‘loop’ fastening material 3 forming one part of a ‘hook and loop’ fastening system. The ‘loop’ fastening material 3 is securely stitched across the full width of the drape-material 2 coincident with the upper-hem. The ‘loop’ fastening material comprises a plurality of fastener units 4, created by the omission of vertical strips of the loops which form the ‘loop’ fastening material. This results in clearly visible gaps 5 in the fastening tape. The gaps 5 constitute the guide markers and are equidistantly spaced.

The fastener units 4 correspond to the width of a louver 6 of a vertical blind system for which the fabric 1 will act as a covering (FIG. 2). Each louver 6 is made from an opaque plastic material such as PVC, which has been treated to provide it with anti-static properties. It is, of course, obvious to a person skilled in the art that the louver may alternatively be translucent and/or may be formed from metal, wood or, when appropriate, a rigid or semi-rigid fabric.

The fabric 1 is intended for use as a covering for a vertical blind, which includes a plurality of louvers 6 wherein the upper portion of each louver 6 includes a ‘hook’ fastening part 7 of the ‘hook and loop’ fastening system. The ‘hook’ fastening part 7 is adhered to the upper edge of both major faces of the louver 6 using a suitable adhesive.

The fabric 1 is secured to the louver 6, using the guide markers 5, such that each of the ‘hook’ fastening parts 7 are secured to a corresponding ‘loop’ fastener unit 4 of the fabric 1. The gaps 5 between the ‘loop’ fastener units 4 correspond to side edge portions of the louvers 6 which are not provided with a ‘hook’ fastening portion 7.

The fabric 1 is secured to the vertical blind as follows: first and second fastening units 4 are attached to respective major faces of a first louver 6. The third fastening unit 4 then acts as a spacer 8, and is not adhered to a louver. This provides an arcuate portion of the drape material 1 through which light may pass when the blind is in the open position (FIG. 3). The fourth and fifth fastening units 4 are attached to a second louver, adjacent to the first louver and the sixth fastening unit 4 again acts as a spacer. The process repeated with successive adjacent louvers 6 until the fabric 1 is attached to each of louvers 6 of the vertical blind.

The vertical blind is of conventional construction wherein each louver 6 is carried by a carrier truck (not shown), which in turn is slidably mounted within a head rail (not shown). This construction will be well known to a person skilled in the art. The carrier trucks facilitate operation of the vertical blind and include a means by which the angular orientation of the louvers may be varied and a means by which their displacement across the window may be controlled. A plurality of louvers 6 are provided for each blind and the carrier trucks are controlled for example by a conventional cord and chain assembly.

When the louvers are mutually parallel to one another and normal to the window, light may be transmitted through the blind. However, unlike conventional vertical blind systems, the fabric covering maintains privacy (FIG. 4), as the blind in this configuration is not transparent. Rotation of the louvers 6 to a closed position (i.e. substantially co-planar and parallel to the window) provides opacity and causes the fabric covering to fold neatly around the louvers 6 (FIG. 5). In this way, the blind system is aesthetically pleasing when both open and closed.

It will be understood that the louvers 6 may be rotated in either direction, clockwise or counter-clockwise, from a fully open position to a fully closed position and may be held at any rotational degree between. Thus the amount of light transmitted may be fully regulated.

In this embodiment of the present invention the lower portion of the fabric 1 is hemmed across the full width of the drape-material 1. To stabilise the covering against drafts and other circulating air currents, circular elements (not shown) of an ‘loop’ part of a ‘hook and loop’ fastening system are stitched to the lower portion of the fabric 1, at positions which correspond substantially to a transverse mid-point of each major surface of each louver 6. Complimentary circular elements (not shown) of the ‘hook’ part of the ‘hook and loop’ fastening system are adhered to the transverse mid-point of each side of each louver 6 whereby regions of the lower portion of the fabric 1 are releasably secured to respective portions of the louvers 6.

It is to be understood that the present invention has been described above with reference to a certain specific example only, which is to be construed as not limiting the scope of the invention in any way. In particular, various changes and modifications from that which has been specifically described and illustrated may be made within the scope of the invention as claimed, as will be readily apparent to persons skilled in the art.

1. A fabric for use with louver-type vertical blinds, the fabric comprising a flexible drape-material and a band comprising one part of a ‘hook and loop’ fastening system, the one part of the fastening system including integral guide markers, whereby attachment of the fabric to a vertical blind is simplified.

2. A fabric according to claim 1, wherein the guide markers comprise gaps created through the omission of portions of the part of the fastening system provided on the fabric.

3. A fabric according to claim 1, wherein the guide markers are selected from contrastingly colored regions, rigid inserts or tags, thickness variations within the fabric or breaks in one part of the fastening system provided on the fabric.

4. A fabric according to claim 1 to 3, wherein the guide markers are equidistantly spaced.

5. A fabric according to any one of claims 1 to 4, wherein the guide markers have a constant width.

6. A fabric according to any one of claims 1 to 5, wherein the one part of the ‘hook and loop’ fastening system comprises alternating regions of either ‘hooks’ or ‘loops’ and gaps.

7. A fabric according to claim 6 wherein the regions of either ‘hooks’ or ‘loops’ have a first width and the gaps have a second width, wherein the first width is greater than the second width.

8. A fabric according to any one of claims 1 to 7, wherein the drape material is a woven or non-woven textile material.

9. A fabric according to claim 8, wherein the drape material is unpleated.

10. A fabric according to claim 8 or claim 9, wherein the drape material is translucent.

11. A fabric according to any of one claims 1 to 10, wherein the drape material is resistant to fading, heat transmission, light transmission or a combination thereof.

12. A fabric according to any one of claims 1 to 11, wherein a lower portion of the fabric is provided with a further part of a ‘hook and loop’ fastening system.

13. A window covering system comprising a plurality of vertical louvers and a fabric according to any one of claims 1 to 12, wherein the fabric is releasably secured to at least some of the louvers, via a ‘hook and loop’ fastening system.

14. A window covering system according to claim 13, wherein the fastening system is located such that the fabric is releasably secured to the upper portion of all of the louvers via the ‘hook and loop’ fastening system.

15. A window covering system according to claim 13 or claim 14, wherein an upper portion of each louver includes a region provided with the other part of the ‘hook and loop’ fastening system.

16. A window covering system according to any one of claims 13 to 15, wherein the regions of ‘hooks’ or ‘loops’ on the upper portion of the fabric are aligned with corresponding regions of the other of the ‘hooks’ or ‘loops’ provided on the louvers.

17. A window covering system according to any one of claims 13 to 16, wherein adjacent guide markers of the fabric define therebetween a fastening unit and every third fastening unit is not secured to a portion of a louver.

18. A window covering system according to any one of claims 13 to 17, wherein each louver is opaque.

19. A window covering system according to any one of claims 13 to 18, wherein each louver is made from a polymer material, metal, wood, or a rigid or semi-rigid fabric material.

20. A fabric substantially as herein described with references to the accompanying drawings.

21. A window covering system substantially as herein described with reference to the accompanying drawings.
